(19) United States
(12) Patent Application Publication
(10) Pub. No.: US 2017/0001375 A1
(43) Pub. Date: Jan. 5, 2017

(54) SINTER SHELL

(71) Applicant: SHAPEWAYS, INC., New York, NY (US)

(72) Inventor: Robert Melly, Woodside, NY (US)

(21) Appl. No.: 14/790,524

(22) Filed: Jul. 2, 2015

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

According to some aspects, system and methods for generating a 3D model shell is provided. The system may include a memory and at least one processor coupled to the memory and specially configured to morphologically dilate a 3D model by a dilation distance, create a first copy of the 3D model and a second copy of the 3D model, perform morphological erosion on the first copy to generate a first shrunken model, perform morphological erosion on the second copy to generate a second shrunken model, and subtract the second shrunken model from the first shrunken model to generate the 3D model shell.

### BACKGROUND

Technical Field

Aspects of the present application relate to 3D printing, and more specifically, to methods and systems of printing 3D cases to protect newly-printed parts through production and shipping.

Background Discussion

Currently, to protect a 3D-printed item from misidentification or damage during production, boxes may be printed based on the largest dimensions of a 3D-printed item or a set of 3D-printed items. Methods exist to create a 3D-printed box that is printed along with an object to protect the object. However, it is appreciated that these 3D-printed boxes are expensive due to a large amount of sintered material required to encase a whole object. They are also expensive as far as capacity usage, especially in the case of an object with odd proportions. There is also a reliability degradation problem when many 3D-printed boxes are used and placed on the same layer of a tray build. In some instances, a machine crash may occur due to different-sized, 3D-printed boxes being placed adjacent to each other. Further, it is appreciated that other problems in the printing process may occur, such as problems with identifying printed items within 3D-printed boxes. More specifically, identification problems may occur due to many boxes looking similar to each other.

### SUMMARY

Embodiments of the present application provide systems and methods for creating a 3D-printed shell that is “shrink-wrapped” around an item. Other embodiments provide for customizable shells that may be 3D-printed with an object as a gift wrap for an object. As discussed herein, such 3D-printed shells may be referred to as “sinter shells.”

According to some aspects, a method for generating a 3D model shell is provided. The method includes acts of morphologically dilating a 3D model by a dilation distance, creating a first copy of the 3D model and a second copy of the 3D model, performing morphological erosion on the first copy to generate a first shrunken model, performing morphological erosion on the second copy to generate a second shrunken model and subtracting the second shrunken model from the first shrunken model to generate the 3D model shell.

In some embodiments, the method further includes generating a pattern grid, and intersecting the pattern grid and the 3D model shell to generate a grid shell. In some embodiments, the method further includes generating a text blank and a text model, unioning the text blank and the pattern grid to generate a text blank and pattern grid combination, and subtracting the text model from the grid shell, wherein intersecting the pattern grid and the 3D model shell includes intersecting the text blank and pattern grid combination and the 3D model shell to generate the grid shell.

In some embodiments, the method further includes an act of generating the pattern grid including an act of generating a package grid and wherein the act of intersecting the pattern grid and the 3D model shell includes an act of intersecting the package grid and the 3D model shell to generate the grid shell. In some embodiments, the method further includes generating an appendage, and unioning the appendage to the package grid shell.

In some embodiments, performing morphological erosion on the first copy further includes an act of performing morphological erosion on the first copy by the dilation distance minus a gap distance and a thickness to generate the first shrunken model and wherein the act of performing morphological erosion on the second copy includes performing morphological erosion on the second copy by the dilation distance minus the gap distance to generate the second shrunken model. In some embodiments, the method further includes printing the 3D model shell.

According to some aspects, a system for generating a 3D model shell is provided. The system may include a memory and at least one processor coupled to the memory and specially configured to morphologically dilate a 3D model by a dilation distance, create a first copy of the 3D model and a second copy of the 3D model, perform morphological erosion on the first copy to generate a first shrunken model, perform morphological erosion on the second copy to generate a second shrunken model, and subtract the second shrunken model from the first shrunken model to generate the 3D model shell.

In some embodiments, the processor is further configured to generate a pattern grid and intersect the pattern grid and the 3D model shell to generate a grid shell. In some embodiments, the processor is further configured to generate a text blank and a text model, union the text blank and the pattern grid to generate a text blank and pattern grid combination, intersect the text blank and pattern grid combination and the 3D model shell to generate the grid shell, and subtract the text model from the grid shell.

In some embodiments, the processor is further configured to generate a package grid and intersect the package grid and the 3D model shell to generate the grid shell. In some embodiments, the processor is further configured to generate an appendage, and union the appendage to the package grid shell. In some embodiments, the processor is further configured to perform morphological erosion on the first copy by the dilation distance minus a gap distance and a thickness to generate the first shrunken model and perform morphological erosion on the second copy by the dilation distance minus the gap distance to generate the second shrunken model. In some embodiments, the system includes a 3D printer and wherein the processor is further configured to print the 3D model shell via the 3D printer.

According to some aspects, a computer-readable medium having stored thereon sequences of instruction is provided. In some embodiments, the sequences of instruction include instructions that will cause at least one processor to morphologically dilate a 3D model by a dilation distance, create a first copy of the 3D model and a second copy of the 3D model, perform morphological erosion on the first copy to generate a first shrunken model, perform morphological erosion on the second copy to generate a second shrunken model, and subtract the second shrunken model from the first shrunken model to generate the 3D model shell.

In some embodiments, the sequences of instruction further include instructions that will cause the at least one processor to generate a pattern grid and intersect the pattern grid and the 3D model shell to generate a grid shell. In some embodiments, the sequences of instruction further include instructions that will cause the at least one processor to generate a text blank and a text model, union the text blank and the pattern grid to generate a text blank and pattern grid combination, intersect the text blank and pattern grid combination and the 3D model shell to generate the grid shell, and subtract the text model from the grid shell.

In some embodiments the sequences of instruction further include instructions that will cause the at least one processor to generate a package grid and intersect the package grid and the 3D model shell to generate the grid shell. In some embodiments, the sequences of instruction further include instructions that will cause the at least one processor to generate an appendage and union the appendage to the package grid shell.

In some embodiments, the sequences of instruction further include instructions that will cause the at least one processor to perform morphological erosion on the first copy by the dilation distance minus a gap distance and a thickness to generate the first shrunken model and perform morphological erosion on the second copy by the dilation distance minus the gap distance to generate the second shrunken model.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein are for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently-disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example 3D model, according to one embodiment;

FIG. 2 illustrates a prior art conventional 3D box;

FIG. 3 is an example process flow diagram for generating a 3D model shell, according to one embodiment;

FIG. 4 illustrates an example dilated 3D model according to one embodiment;

FIG. 5A illustrates an example of half of a 3D model shell according to one embodiment;

FIG. 5B illustrates an example of a 3D model shell according to one embodiment;

FIG. 6A illustrates an example conceptual model of a 3D model shell according to one embodiment;

FIG. 6B illustrates an example conceptual process for generating a 3D model shell according to one embodiment;

FIG. 7 is an example process flow diagram for generating a grid shell with a text label, according to one embodiment;

FIG. 8A illustrates an example of a sparse grid according to one embodiment;

FIG. 8B illustrates an example of a tight grid according to one embodiment;

FIG. 9 illustrates an example text blank according to one embodiment;

FIG. 10 illustrates an example text model, according to one embodiment;

FIG. 11A illustrates an example sinter shell, according to one embodiment;

FIG. 11B illustrates another example sinter shell, according to one embodiment;

FIG. 12 is an example process flow diagram for generating a latched package grid shell, according to one embodiment; and

FIG. 13 is an example distributed computer system in which various embodiments and aspects may be practiced.

### DETAILED DESCRIPTION

Some embodiments disclosed herein include systems and methods for 3D printing an object with a 3D-printed sinter shell around the object. Such 3D-printed sinter shells may have a primary use for protecting the 3D-printed object. The sinter shell also may be used to perform other functions, such as being used to sort different groups of objects being printed, to contain small objects, and to identify objects. A sinter shell may be created by wrapping the shell around an object or group of objects, and as a result, sinter shells need less material than current methods of 3D printing a box around an object or group of objects. Further, a sinter shell may be generated using the smallest dimension of an object as the threshold size of openings in the sinter shell so that the cost of generating the sinter shell is reduced while still securely protecting objects within the sinter shell. In some embodiments, the sinter shell may be generated using a modified process of morphological closing, which is a process that includes a morphological dilation followed by a morphological erosion.

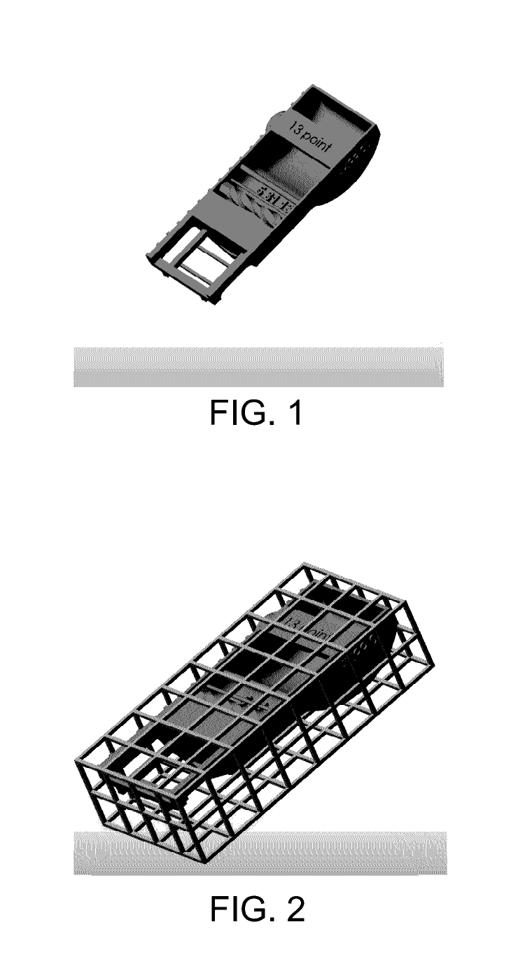

FIG. 1 illustrates an example 3D model. FIG. 2 illustrates a 3D-printed box that is used in a conventional method to contain a 3D-printed object, such as the 3D-printed object shown in FIG. 1. As illustrated, the box has additional room that is not being used and the cost of the material used to create the box is high. Further, each 3D object needs its own box. If multiple 3D objects need to be contained, a much larger box associated with the multiple objects would need to be constructed that contains all of the objects, and the overall cost of the box would be expensive.

### Sinter Shell Creation

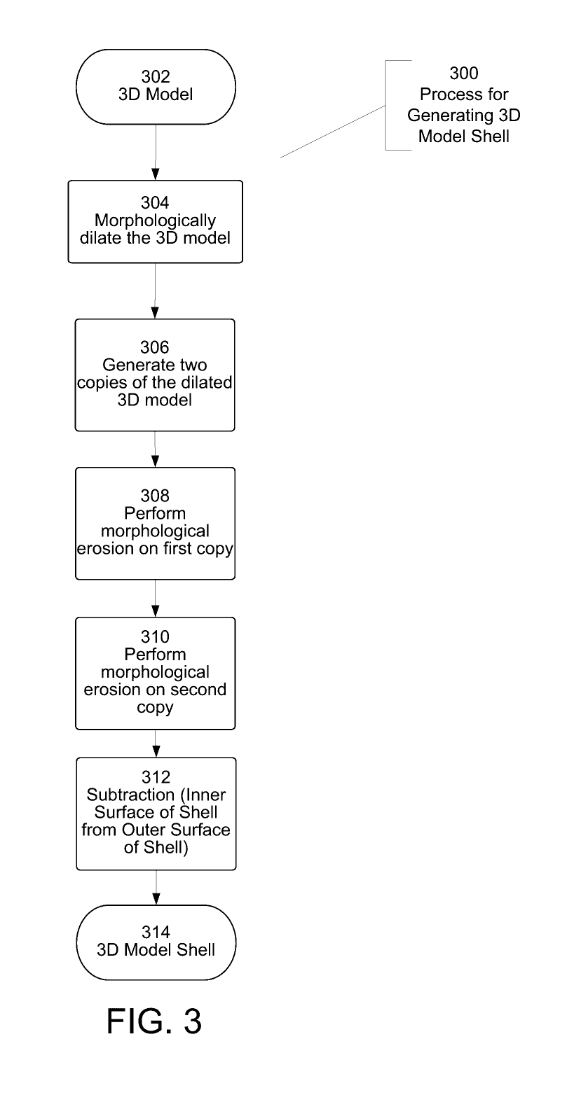

FIG. 3 illustrates an example process 300 for creating a sinter shell according to one embodiment. For example, the process 300 may be used to generate a 3D shell around a 3D model to be printed. For instance, such a process 300 may be executed by a system that is used to design and/or submit 3D models for printing on a 3D printer. The 3D model may include one or many different objects. For instance, in the case of printing multiple objects, different associated objects (e.g., parts associated with a particular order, assembly, or other grouping) may be printed within a single sinter shell. In another example, multiple objects of the same type may be printed and held by a sinter shell. Also, the 3D model may take up a number of voxels. Process 300 begins at act 302 with a 3D model, having one or more objects that may be used as the base 3D model for building the sinter shell. FIG. 1 illustrates an example 3D model that may be used as a base of a sinter shell. At act 304, a morphological dilation is performed on the 3D model. When the 3D model goes through a morphological dilation, according to one embodiment, the geometry of the 3D model may uniformly expand in all directions by a fixed dilation distance D. Once expanded, the 3D model may be larger than the original 3D model and holes or details that are smaller than a given size may no longer be visible.

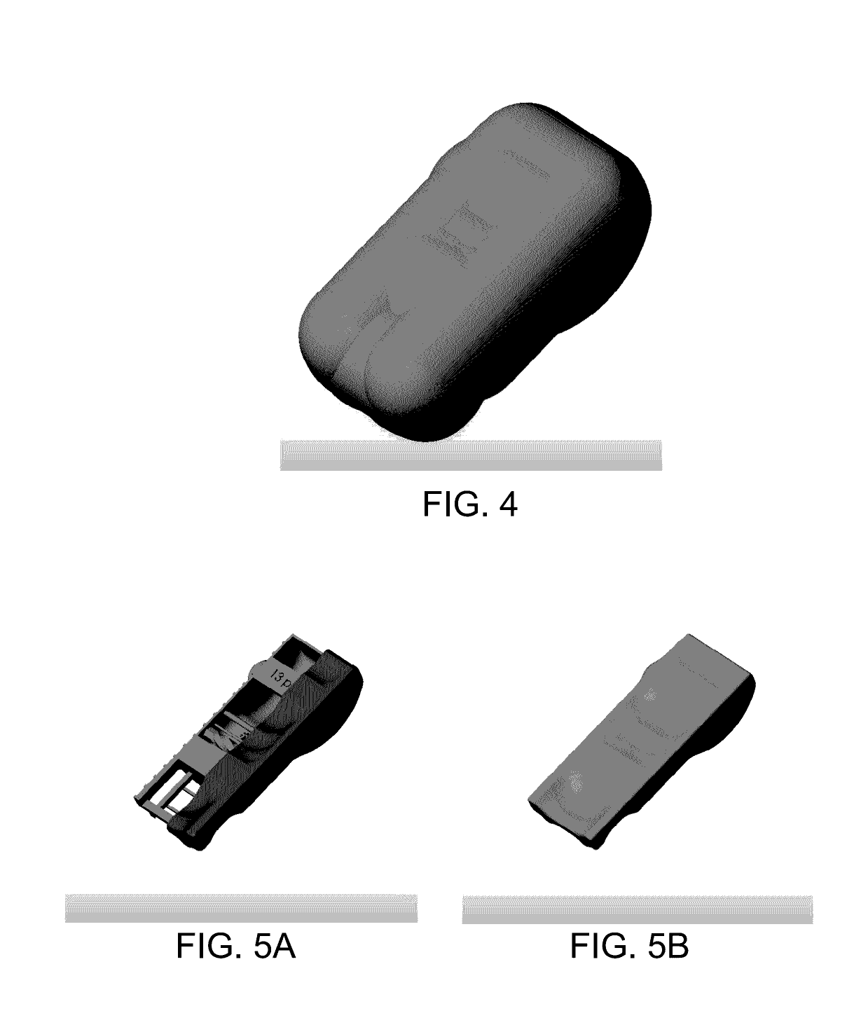

According to some implementations, the dilation distance D may be determined by a user input. According to other implementations, the dilation distance D may be determined by using the largest empty space size of the 3D object. FIG. 4 illustrates an example dilated 3D model. In this example, the 3D model from FIG. 1 is morphologically dilated to create the expanded object in FIG. 4. As shown, the key features of the model are hidden and the expanded object does not look like the original object at all.

Referring back to FIG. 3, at act 306, the dilated 3D model may be copied so that two copies of the dilated model exist (e.g., in a memory of a computer system). At act 308, the first copy of the dilated model is subjected to morphological erosion using the dilation distance D minus the desired gap distance between the shell and the 3D model G and the desired thickness of the shell T for each voxel on the perimeter of the dilated 3D model. A new distance D′ may be calculated by subtracting the desired gap distance between the shell and the 3D model G and the desired thickness of the shell T from the dilation distance D.

According to some aspects, once D′ is calculated, the volume of length D′ is eroded from the perimeter of the expanded 3D model. The process may include uniformly shrinking the expanded object by an amount D′ such that the surface of the shrunk model closely follows the surface of the original model. In some examples, in places where the original model has small concave details, the shrunk model surface may smoothly approximate the details. This erosion causes the 3D model to lose the distance additional to the desired gap distance G and the desired thickness T. Thus, the shrunken model may represent the outer surface of the 3D model shell.

Referring back to FIG. 3, at act 310, the second copy may go through morphological erosion using the dilation distance D minus the desired gap distance between the shell and the 3D model G. The subtraction of the desired distance G from the dilation distance D results in a new distance D″. The distance D″ may be greater than the distance D′. The distance D″ may be equal to the distance D′ plus the desired thickness T.

According to some embodiments, once D″ is calculated, the voxels associated with the distance of D″ may be eroded from the second copy of the expanded model to create a second shrunken model. The second shrunken model may represent the inner surface of the 3D model shell.

Referring back to FIG. 3, at act 312, the second shrunken model representative of the inner surface of the 3D model shell may be subtracted from the first shrunken model representative of the outer surface of the 3D model shell to create the 3D model shell. Once the subtraction is complete, the 3D model shell may be created to be hollow with a thickness T. Due to the gap distance G, the 3D model shell is guaranteed to not intersect with any part of the 3D model, leaving a clean shell that may be placed around the original 3D model without any concern of melding together during fabrication.

Examples of a 3D model shell are illustrated in FIGS. 5A and 5B. FIG. 5A shows half of a shell overlapping a 3D model. FIG. 5B shows a full shell containing the 3D model. As shown, the shell is fitted to the 3D model such that a minimal amount of material is used. According to some implementations, the shell may further be reduced using a smaller thickness T. This enhancement may be more cost efficient, but reduction of the shell thickness also risks damage during shipment and creation of the shell and model.

According to some implementations, the 3D model shell may be printed with a 3D model. According to other implementations, the 3D model shell may receive a latch or opening such that the 3D model may be placed in the shell. According to some examples, 3D models may be placed next to each other in a way that the shell uses the least amount of materials to be created. In other examples, the shell may include a type of net to separate or group different pieces. The net may separate orders so if, for example, 5 copies of a set of 10 puzzle pieces are to be shipped, one shell may include all 5 copies and sort the copies into their own areas in the shell, separated by a net so the pieces do not get mixed up. Referring back to FIG. 3, at act 314, the 3D model shell is complete.

According to at least one implementation, after generating the 3D model shell, additional features of the shell may be generated. For example, a label may be added to indicate the recipient of the 3D model in the shell or the name of the 3D model. Alternatively, a latch or design may be added to the shell for decorative or functional purposes. In other examples, the size of the mesh shell may be determined based on the smallest dimension of an object within a specified range of voxels of the part of the mesh shell. For example, if a model includes a big rectangle and a group of small puzzle pieces next to the rectangle, the size of the holes in the mesh shell in the rectangle side may be bigger than the size of the holes on the mesh shell near the puzzle pieces.

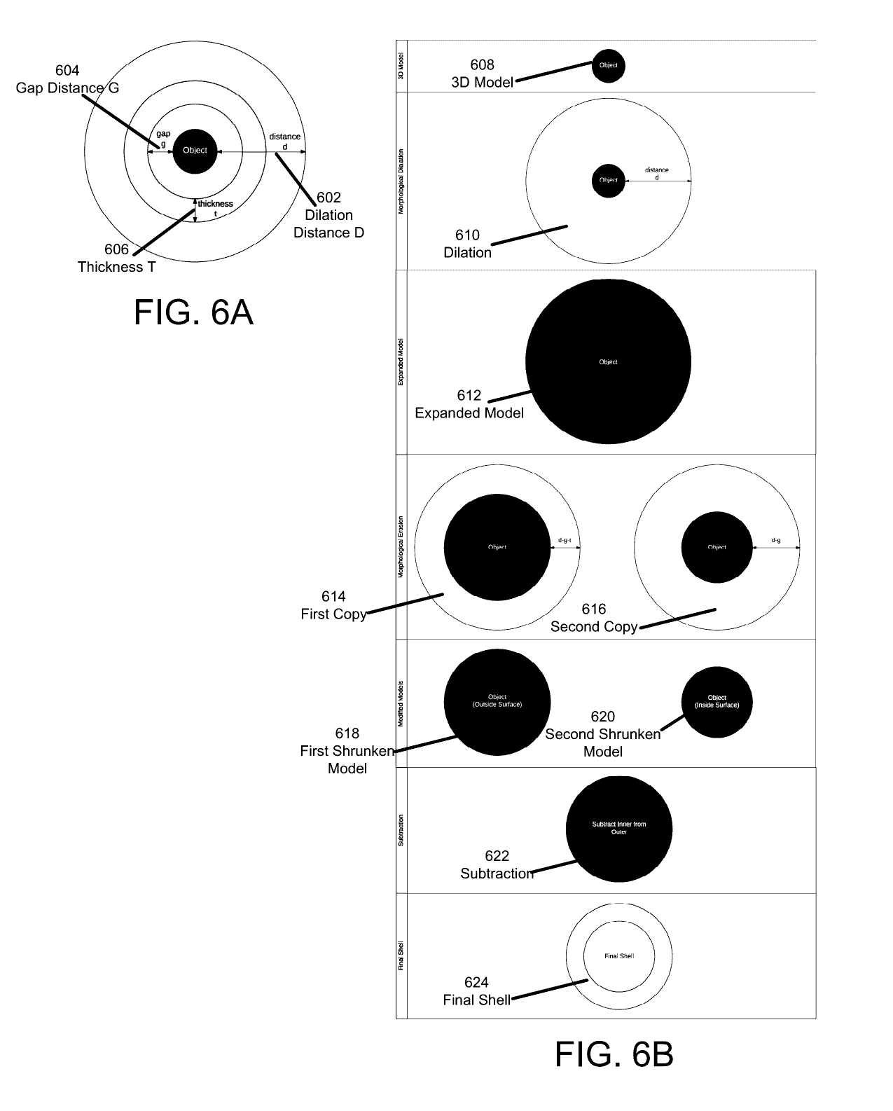

FIGS. 6A and 6B illustrate an example process that illustrates the creation of the shell. FIG. 6A shows a key of an example distance D 602, gap distance G 604, and thickness T 606. As illustrated, darkened areas represent filled voxels (e.g., areas taken up by mass) and whitened areas indicate a lack of mass.

Referring to FIG. 6B, a representation of a 3D model 608 is shown. A dilation process 610 is started and an expanded model 612 is generated by expanding all of the voxels by a specified dilation distance. The expanded model 612 is then copied into a first copy 614 and a second copy 616. A morphological erosion is performed on the first copy 614 determined by the dilation distance D 602 minus the gap distance G 604 and the thickness T 606. A morphological erosion is performed on the second copy 616 determined by the dilation distance D 602 minus the gap distance G 604. After the morphological process, the first copy 614 transforms into the first shrunken model 618 and the second copy 616 transforms into the second shrunken model 620. The first shrunken model 618 may be a dense version of the shell including the thickness T of the shell and the second shrunken model 620 may be a dense version of the shell without the thickness T of the shell. A subtraction 622 of the second shrunken model 620 from the first shrunken model 618 occurs and a final shell 624 is formed with a hollow shell.

### Sinter Shell Pattern Generation

According to some embodiments, once a basic shell is created around a 3D model, various geometries may be intersected with the basic shell to yield a unique shell that may allow for additional functional uses of the shell. For example, a sparse grid may be intersected with the shell to identify a 3D model using a minimal amount of material. The intersection may include overlapping two 3D objects (e.g., the sparse grid and the 3D model) over each other and subtracting any voxels of the two 3D objects that do not overlap. The voxels in a 3D object may each include a Boolean value (e.g., 1 if a voxel exists and 0 if a voxel does not exist and is taken up by an empty space). When two 3D objects overlap, voxels that are true for both 3D objects are kept and voxels that are false for either or both 3D objects are subtracted. For example, a full box of cards intersected with an empty box of cards may result in the empty box of cards, since the contents of the full box are subtracted due to not existing in the empty box.

In another example, a tight grid may be intersected with the grid to result in a more complex shell wrapped around the 3D model to better protect the 3D model during post-production. A tight grid intersection may be useful to keep groups of small 3D models contained. In even other examples, a sparse grid or tight grid may include a label pattern to add text to the shell. In further examples, integral packaging may be used to add a latch or switch to a shell to open or close the shell or hang the shell (e.g., a 3D-printed present may include a shell with a latch to hang the shell and its contents on a Christmas tree). According to various embodiments, one or more processes may be applied to the basic shell to provide one or more additional features. Such processes may be applied to the 3D model to be printed within a memory of a computer system prior to performing the printing operation.

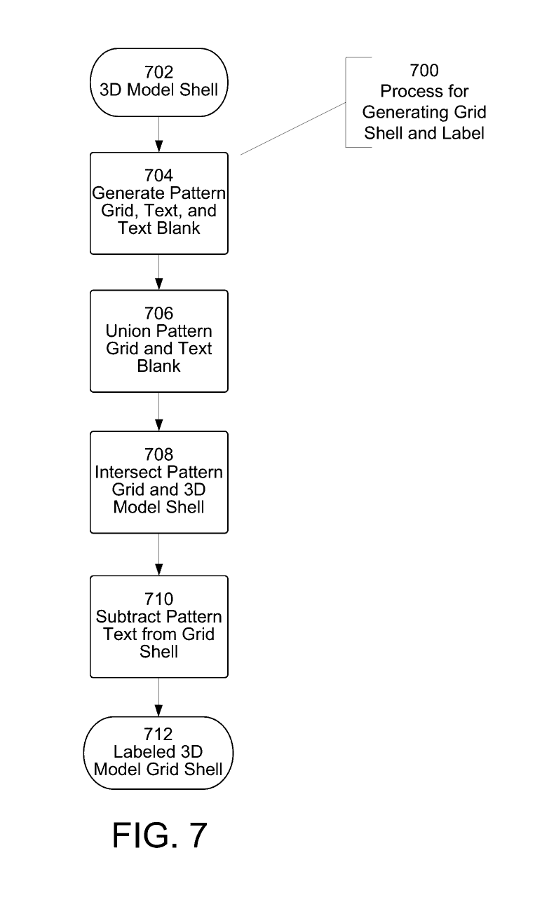

FIG. 7 illustrates an example process 700 for applying a grid to a shell and placing a label on the grid shell. Process 700 begins at act 702 with the 3D model shell generated during process 300. At act 704, a pattern grid such as a sparse grid or a tight grid may be generated. A text blank and corresponding text may also be generated. The pattern grid may be generated either by a manual input with a size of holes in the grid or automatically using the dimensions of the 3D model and adjusting the grid size to a value (e.g., 1 centimeter) below the dimensions of the 3D model. If the pattern grid is automatically generated, the pattern grid may be edited via a manual input. Further, in some examples, the pattern grid may be generated using the dimensions of the closest objects in the 3D model shell.

The text blank may be generated as a cylindrical 3D object with a length of the 3D model shell and a width and height of the size of the text. The text may be generated as a group of numbers, letters, symbols, etc. with the length of the 3D model and the width and height of the text. The text may include words, for example, to identify the 3D model or identify the recipient of the 3D model. The text may include a block with two different words on each end to result in, for example, one side of the text displaying one piece of text and the other side of the text displaying a different piece of text. In addition to text, any design or pattern may be added to the 3D model shell.

At act 706, the pattern grid may be unioned with the text blank to generate a combined pattern grid-text blank combination (e.g., a pattern grid with a text blank cylindrical 3D object going through the middle). Unioning two 3D objects includes overlapping two 3D objects and keeping any voxels that exist in either or both 3D objects. In various examples, each voxel of a 3D object includes a Boolean value of either true if the voxel exists in the 3D object and false if the voxel does not take up volume (e.g., if the voxel consists of empty space). For example, if a horizontal stick is unioned with a vertical stick, a cross may be formed by combining all of the voxels that exist in the vertical stick and the voxels that exist in the horizontal stick. If two overlapping voxels are both true, only one voxel is kept since the two voxels are identical. In some examples, when two 3D objects are unioned, the voxels of one 3D object are added to the voxels of another 3D object. Any voxels from the second object that overlap with voxels from the first object may be discarded since the voxels already exist in the first object.

At act 708, the unioned text blank and pattern grid combination is intersected with the 3D model shell to generate a grid shell that securely protects a 3D model. At act 710, the volume of the pattern text is subtracted from the grid shell. The subtraction of the pattern text volume clears out the space in the original text blank to display the text. At act 712, the labeled 3D model grid shell has been generated and process 700 ends. In some examples, the grid shell may be generated without the text by just intersecting a grid shell with a 3D model shell.

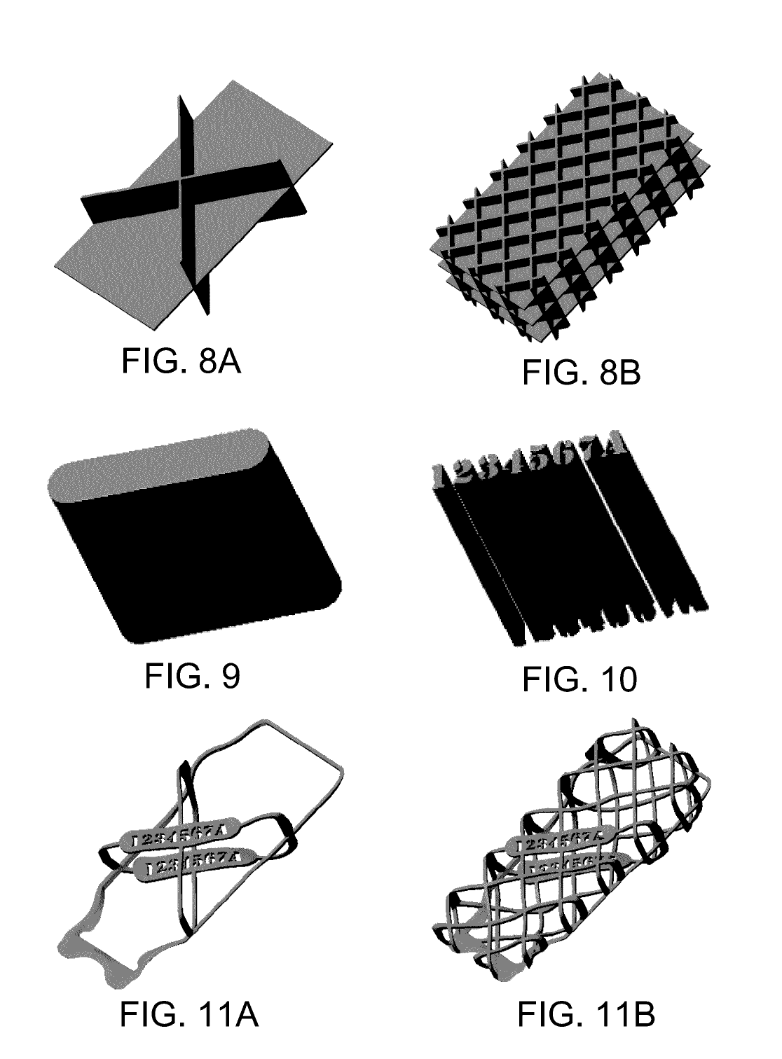

FIGS. 8A and 8B illustrate two grids that may be generated to be intersected with a 3D model shell. FIG. 8A shows a sparse grid that, when intersected with a 3D model shell, may create a loose wrapping around a 3D model. The sparse grid may be useful when a 3D model only consists of one object and there is no concern about small pieces being misplaced or falling off. FIG. 8B shows a tight grid that, when intersected with a 3D model shell, may create a tight wrapping around a 3D model to better secure, protect, and contain the printed 3D model.

FIGS. 11A and 11B illustrate two examples of labeled 3D model grid shells that correspond to the grids illustrated in FIGS. 8A and 8B respectively using the text blank illustrated in FIG. 9 and the text illustrated in FIG. 10. As illustrated, FIG. 11A shows a resulting loop after the sparse grid of FIG. 8A is unioned with the text blank of FIG. 9, the combined sparse grid and text blank is intersected with the original 3D model shell, and the text from FIG. 10 is subtracted from the intersection. Due to the sparse grid being so frugal with materials, the resulting loop of the intersection comprises a thin sinter shell for the model. The loop shown in FIG. 11B resulting from the intersection of the 3D model shell and the tight grid shown in FIG. 8B uses more materials (e.g., plastic, metal, ceramics, wax, sandstone, etc.) than the sparse grid of FIG. 8A. As illustrated in FIG. 11B, the sinter shell is generated such that it covers the whole model and protects the model as well as or better than the conventional 3D box of FIG. 2. For example, the conventional 3D box illustrated in FIG. 2 leaves some room for the model to move around and receive damage, but the sinter shell illustrated in FIG. 11B is shaped around the 3D model to limit movement of the model in the shell.

### Sinter Shell Package Generation

According to some embodiments, instead of using a pattern grid to build a grid shell, a 3D model may be used with a package grid that allows the 3D model to be contained in a shell that is shaped like another 3D model with a hollow inside and a pattern that matches the contents of the 3D model. In some examples appendages such as a latch may be added to the package grid shell to allow for additional functionality. Appendages may include switches, locks, hinges, latches, slider openings, etc. that may be added to a shell.

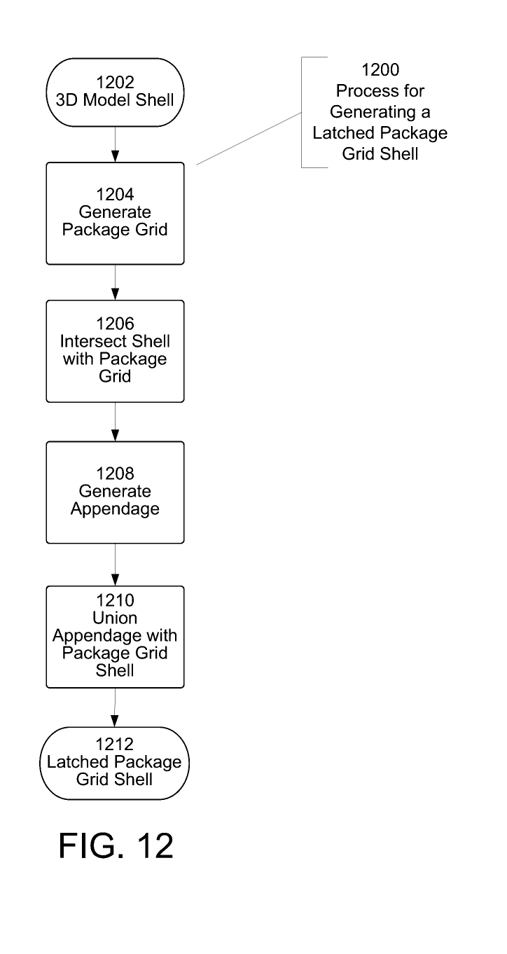

FIG. 12 illustrates an example process 1200 for generating a latched package grid shell. Process 1200 begins at act 1202 when the 3D model shell from process 300 is generated. At act 1204, a package grid is generated. A package grid may include a design or 3D object that may house a 3D model. The density of the package grid may also be set based on the desired protection level of the 3D model.

According to at least one embodiment, a package grid shell may be a design to be used as a package for a 3D model. For example, an apple package grid may be generated with dimensions similar to the model shell such that when the package grid is intersected with the 3D model shell, an outer design may be an apple but the inner shell surrounding the 3D model may still be a wrapping around the model with the desired gap distance.

At act 1206, the package grid may be intersected with the 3D model shell so the package grid is perfectly built around the 3D model. In some implementations, the thickness of the shell may be increased to match the package grid such that the aesthetics of the package grid design are visible after the intersection. At act 1208, an appendage or appendages are generated. As described above, the appendage may be a latch, lock, switch, slider, hinge, etc. At act 1210, the appendage may be unioned with the package grid shell in a way that adds the appendage to the shell. For example, if a package grid shell includes two halves of an apple, a latch may be added to one edge of the apple and a hinge may be added to the other end so the apple can open to release the 3D model inside or close without fully coming apart.

According to some examples, in addition to a package grid and an appendage, an additional pattern grid may be intersected with the shell to create a pattern along with a package grid. Additionally or alternatively, a text blank may be unioned with the package grid and the text may be subtracted from the unioned object to create a label in the sinter shell, as described in FIG. 7. The text may be subtracted from the unioned object to add an identifier, text, or a symbol. Further, a 3D-printed shell may include visual sorting to separate parts that need more processing from parts that do not. For example, if parts of an order need polishing or coloring, a scaffolding or net within the shell may be used to separate the parts that need more processing and the parts that do not. Further, if parts are to be separated by color or size, the shell may additionally separate those parts via visual recognition.

In some embodiments, the shell is automatically printed with the 3D model in the shell. In these embodiments, the objects in the 3D model may be automatically sorted by color and a scaffolding or net may be generated between them. In other embodiments, the divisions in the shell may be edited via manual input from a user. Dividing 3D objects by color may help sort different groups of objects as well as avoid color from rubbing onto other objects immediately after production.

According to some implementations, the text pattern may include a fiducial. The fiducial may be scanned by a specially configured computer to determine the order number of a 3D model, the shipping address, recipient, price, and other information. The fiducial may be uniquely generated for each sinter shell generated.

### Specialized Computer System

Various aspects and functions described herein, including the processes illustrated in FIGS. 3, 7, and 12, may be implemented as specialized hardware or software components executing in one or more computer systems. There are many examples of computer systems that are currently in use. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Examples of particular models of mobile computing devices include iPhones, iPads, and iPod touches running the iOS operating system available from Apple, Android devices like Samsung Galaxy Series, LG Nexus, and Motorola Droid X, Blackberry devices available from Blackberry Limited, and Windows Phone devices. Further, aspects may be located on a single computer system or may be distributed among a plurality of computer systems connected to one or more communications networks.

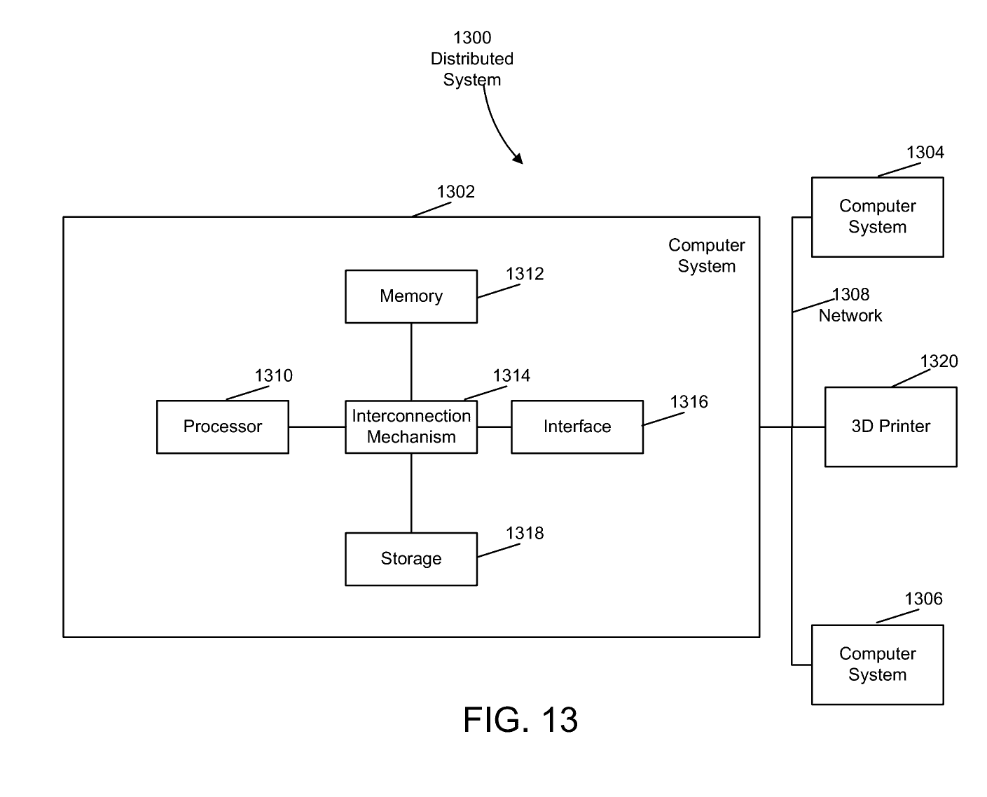

For example, various aspects, functions, and processes may be distributed among one or more computer systems configured to provide a service to one or more client computers, or to perform an overall task as part of a distributed system, such as the distributed computer system 1300 shown in FIG. 13. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

The specialized computer system may store files and shells in memory and generate the sinter shell for a 3D model using a processor connected to the memory. The specialized computer system may be configured to manipulate the 3D model by adding a sinter shell and then editing the sinter shell. Further, the sinter shell may be printed by the specialized computer system via a 3D printer. The sinter shell may be printed with a 3D model enclosed in the sinter shell or the sinter shell may be printed separately. According to some embodiments, the 3D printer may be specially configured to include a visualization component that may perform intelligent grouping on a set of objects in a 3D model. Conversely, the application on the computer system may include a sorting function executed by the processor to sort the objects in a 3D model within areas of a sinter shell prior to printing the objects and sinter shell.

Referring to FIG. 13, there is illustrated a block diagram of a distributed computer system 1300, in which various aspects and functions are practiced. As shown, the distributed computer system 1300 includes one or more computer systems that exchange information. More specifically, the distributed computer system 1300 includes computer systems 1302, 1304, and 1306. As shown, the computer systems 1302, 1304, and 1306 are interconnected by, and may exchange data through, a communication network 1308. The network 1308 may include any communication network through which computer systems may exchange data. To exchange data using the network 1308, the computer systems 1302, 1304, and 1306 and the network 1308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 1302, 1304, and 1306 may transmit data via the network 1308 using a variety of security measures including, for example, SSL or VPN technologies. While the distributed computer system 1300 illustrates three networked computer systems, the distributed computer system 1300 is not so limited and may include any number of computer systems and computing devices, networked using any medium and communication protocol.

As illustrated in FIG. 13, the computer system 1302 includes a processor 1310, a memory 1312, an interconnection element 1314, an interface 1316 and data storage element 1318. To implement at least some of the aspects, functions, and processes disclosed herein, the processor 1310 performs a series of instructions that result in manipulated data. The processor 1310 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 1310 is connected to other system components, including one or more memory devices 1312, by the interconnection element 1314.

The memory 1312 stores programs (e.g., sequences of instructions coded to be executable by the processor 1310) and data during operation of the computer system 1302. Thus, the memory 1312 may be a relatively high performance, volatile, random access memory such as a dynamic random access memory (“DRAM”) or static memory (“SRAM”). However, the memory 1312 may include any device for storing data, such as a disk drive or other nonvolatile storage device. Various examples may organize the memory 1312 into particularized and, in some cases, unique structures to perform the functions disclosed herein. These data structures may be sized and organized to store values for particular data and types of data.

Components of the computer system 1302 are coupled by an interconnection element such as the interconnection element 1314. The interconnection element 1314 may include any communication coupling between system components such as one or more physical busses in conformance with specialized or standard computing bus technologies such as IDE, SCSI, PCI and InfiniBand. The interconnection element 1314 enables communications, including instructions and data, to be exchanged between system components of the computer system 1302.

The computer system 1302 also includes one or more interface devices 1316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1302 to exchange information and to communicate with external entities, such as users and other systems.

The data storage element 1318 includes a computer readable and writeable nonvolatile, or non-transitory, data storage medium in which instructions are stored that define a program or other object that is executed by the processor 1310. The data storage element 1318 also may include information that is recorded, on or in, the medium, and that is processed by the processor 1310 during execution of the program. More specifically, the information may be stored in one or more data structures specifically configured to conserve storage space or increase data exchange performance. The instructions may be persistently stored as encoded signals, and the instructions may cause the processor 1310 to perform any of the functions described herein. The medium may, for example, be optical disk, magnetic disk or flash memory, among others. In operation, the processor 1310 or some other controller causes data to be read from the nonvolatile recording medium into another memory, such as the memory 1312, that allows for faster access to the information by the processor 1310 than does the storage medium included in the data storage element 1318. The memory may be located in the data storage element 1318 or in the memory 1312, however, the processor 1310 manipulates the data within the memory, and then copies the data to the storage medium associated with the data storage element 1318 after processing is completed. A variety of components may manage data movement between the storage medium and other memory elements and examples are not limited to particular data management components. Further, examples are not limited to a particular memory system or data storage system.

Although the computer system 1302 is shown by way of example as one type of computer system upon which various aspects and functions may be practiced, aspects and functions are not limited to being implemented on the computer system 1302 as shown in FIG. 13. Various aspects and functions may be practiced on one or more computers having different architectures or components than those shown in FIG. 13. For instance, the computer system 1302 may include specially-programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1302 may be a computer system including an operating system that manages at least a portion of the hardware elements included in the computer system 1302. In some examples, a processor or controller, such as the processor 1310, executes an operating system. Examples of a particular operating system that may be executed include a Windows-based operating system, such as Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating system available from various sources. Many other operating systems may be used, and examples are not limited to any particular operating system.

The processor 1310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Java, C++, C# (C-Sharp), Python, or JavaScript. Other object-oriented programming languages may also be used. Alternatively, functional, scripting, or logical programming languages may be used.

The processes described above may be implemented using an application for 3D modeling. The application may be a web application that communicates with a web server to process requests. The application may receive various files including computer-aided design (CAD) files or STereoLithography (STL) files and process the files to generate a sinter shell. A specialized computer system configured to run an application to generate a sinter shell may be in data communication with a 3D printer 1320. Examples of a 3D printer 1320 may include 3D printing and manufacturing systems by Electro Optical Systems (EOS) such as the EOS Formiga P100, EOS Formiga P 110, EOS P 395, EOS P 396, EOSINT P 760, EOSINT P 800, EOSINT M 280, the EOS M 290, the EOS M 400, and the Precious M 080. Other examples of a 3D printer 1320 may include the Ultimaker 2, the Cubify CubePro, the Cubify CubeX, the Lulzbot TAZ, the Airwolf AW3D HD, the Mbot Grid, the Cubify Cube, the Type A Series 1, the Afinia H, the Airwolf AW3D XL, the Ditto Pro, the DeeGreen, the Formlabs Form 1+ Desktop 3D printer, the XYZprinting daVinci 1.0 3D printer, and any other 3D printer.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the application is not limited to a particular computer system platform, processor, operating system, network, or communication protocol. Also, it should be apparent that the present application is not limited to a specific architecture or programming language.

Having now described some illustrative aspects of the application, it should be apparent to those skilled in the art that the foregoing is merely illustrative and not limiting, having been presented by way of example only. While the bulk of this disclosure is focused on embodiments directed to business management, aspects of the present application may be applied to other information domains, for instance law and scientific disciplines. Similarly, aspects of the present application may be used to achieve other objectives including assisting other types of users, such as domain information experts, in their analysis of specific information domains. Numerous modifications and other illustrative embodiments are within the scope of one of ordinary skill in the art and are contemplated as falling within the scope of the application. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A method for generating a 3D model shell, the method comprising acts of:
morphologically dilating a 3D model by a dilation distance;
creating a first copy of the 3D model and a second copy of the 3D model;
performing morphological erosion on the first copy to generate a first shrunken model;
performing morphological erosion on the second copy to generate a second shrunken model; and
subtracting the second shrunken model from the first shrunken model to generate the 3D model shell.

2. The method according to claim 1, further comprising acts of:
generating a pattern grid; and
intersecting the pattern grid and the 3D model shell to generate a grid shell.

3. The method according to claim 2, further comprising acts of:
generating a text blank and a text model;
unioning the text blank and the pattern grid to generate a text blank and pattern grid combination; and
subtracting the text model from the grid shell,
wherein intersecting the pattern grid and the 3D model shell includes intersecting the text blank and pattern grid combination and the 3D model shell to generate the grid shell.

4. The method according to claim 2, wherein the act of generating the pattern grid includes an act of generating a package grid and wherein the act of intersecting the pattern grid and the 3D model shell includes an act of intersecting the package grid and the 3D model shell to generate the grid shell.

5. The method according to claim 4, further comprising acts of:
generating an appendage; and
unioning the appendage to the package grid shell.

6. The method according to claim 1, wherein the act of performing morphological erosion on the first copy further comprises an act of performing morphological erosion on the first copy by the dilation distance minus a gap distance and a thickness to generate the first shrunken model and wherein the act of performing morphological erosion on the second copy includes performing morphological erosion on the second copy by the dilation distance minus the gap distance to generate the second shrunken model.

7. The method according to claim 1, further comprising printing the 3D model shell.

8. A system for generating a 3D model shell, the system including a memory and at least one processor coupled to the memory and specially configured to:
morphologically dilate a 3D model by a dilation distance;
create a first copy of the 3D model and a second copy of the 3D model;
perform morphological erosion on the first copy to generate a first shrunken model;
perform morphological erosion on the second copy to generate a second shrunken model; and
subtract the second shrunken model from the first shrunken model to generate the 3D model shell.

9. The system according to claim 8, wherein the processor is further configured to:
generate a pattern grid; and
intersect the pattern grid and the 3D model shell to generate a grid shell.

10. The system according to claim 9, wherein the processor is further configured to:
generate a text blank and a text model;
union the text blank and the pattern grid to generate a text blank and pattern grid combination;
intersect the text blank and pattern grid combination and the 3D model shell to generate the grid shell; and
subtract the text model from the grid shell.

11. The system according to claim 9, wherein the processor is further configured to generate a package grid and intersect the package grid and the 3D model shell to generate the grid shell.

12. The system according to claim 11, wherein the processor is further configured to:
generate an appendage; and
union the appendage to the package grid shell.

13. The system according to claim 8, wherein the processor is further configured to perform morphological erosion on the first copy by the dilation distance minus a gap distance and a thickness to generate the first shrunken model and perform morphological erosion on the second copy by the dilation distance minus the gap distance to generate the second shrunken model.

14. The system according to claim 8, wherein the system includes a 3D printer and wherein the processor is further configured to print the 3D model shell via the 3D printer.

15. A computer readable medium having stored thereon sequences of instruction including instructions that will cause at least one processor to:
morphologically dilate a 3D model by a dilation distance;
create a first copy of the 3D model and a second copy of the 3D model;
perform morphological erosion on the first copy to generate a first shrunken model;
perform morphological erosion on the second copy to generate a second shrunken model; and
subtract the second shrunken model from the first shrunken model to generate the 3D model shell.

16. The computer readable medium according to claim 15, wherein the sequences of instruction further include instructions that will cause the at least one processor to generate a pattern grid and intersect the pattern grid and the 3D model shell to generate a grid shell.

17. The computer readable medium according to claim 16, wherein the sequences of instruction further include instructions that will cause the at least one processor to:
generate a text blank and a text model;
union the text blank and the pattern grid to generate a text blank and pattern grid combination;
intersect the text blank and pattern grid combination and the 3D model shell to generate the grid shell; and
subtract the text model from the grid shell.

18. The computer readable medium according to claim 16, wherein the sequences of instruction further include instructions that will cause the at least one processor to generate a package grid and intersect the package grid and the 3D model shell to generate the grid shell.

19. The computer readable medium according to claim 16, wherein the sequences of instruction further include instructions that will cause the at least one processor to generate an appendage and union the appendage to the package grid shell.

20. The computer readable medium according to claim 15, wherein the sequences of instruction further include instructions that will cause the at least one processor to perform morphological erosion on the first copy by the dilation distance minus a gap distance and a thickness to generate the first shrunken model and perform morphological erosion on the second copy by the dilation distance minus the gap distance to generate the second shrunken model.
